(19) United States
(12) Patent Application Publication
(10) Pub. No.: US 2023/0046233 A1
(43) Pub. Date: Feb. 16, 2023

(54) Apparatus, Method, and System for Supplier Partnership Program

(71) Applicant: Stephen R. Scrase, Langford (CA)

(72) Inventors: Stephen R. Scrase, Langford (CA); Scott D. Hoerr, Sabetha, KS (US)

(21) Appl. No.: 17/975,896

(22) Filed: Oct. 28, 2022

Related U.S. Application Data
(63) Continuation-in-part of application No. 17/335,762, filed on Jun. 1, 2021, now abandoned.
(60) Provisional application No. 63/420,176, filed on Oct. 28, 2022.

(51) Int. Cl. G06Q 30/06

(52) U.S. Cl. CPC G06Q 30/0613; G06Q 30/0639

(57) ABSTRACT

A method and software product for implementing the method of providing compensation from an on-line seller to a contractually unaffiliated retail outlet based on an on-line seller receiving an on-line order for a product from a customer. The on-line seller determines the identity of the retail outlet where showrooming of the product occurred, and contacts the retail outlet to offer payment associated with the on-line order of the product.

This application claims priority from and incorporates by reference in its entirety U.S. patent application Ser. No. 17/355,762 filed Jun. 1, 2021 and U.S. provisional patent application Ser. No. 63/033,155 filed on Jun. 1, 2020, and also claims priority from and incorporates by reference in its entirety U.S. provisional patent application Ser. No. 63/195,238 filed on Jun. 1, 2021 both of which are incorporated by reference in the pending Ser. No. 17/355,762 application.

This application claims priority from and incorporates by reference in its entirety U.S. provisional patent application Ser. No. 63/420,176 filed on Oct. 28, 2022.

### BACKGROUND

Until recently product sales were generally transacted at brick-and-mortar stores and businesses, by travelling salesmen at the client site, or via the telephone after the customer reviewed a product catalog or sales brochure. In each situation the potential client had the opportunity to experience the product either in person, or see the product in the company's catalog, before making a purchase decision. The advent of the Internet changed the way many companies do business. Sales today are often transacted over the Internet, putting customers in touch with a myriad of different suppliers for their varied product needs.

While Internet sales have grown in popularity and volume to a significant percentage of all product sales, there are still some items that the purchaser prefers to see in person before making a purchase decision. For example, many customers like to try on different pairs of shoes to experience the fit and feel before purchasing the item. Similarly, most customers prefer to examine items that may vary in size, quality or other characteristics before making a purchase decision.

### SUMMARY OF THE INVENTION

In various embodiment implementing the methods and software products disclosed herein an on-line seller provides compensation to a contractually unaffiliated retail outlet based on an on-line seller receiving an on-line order for a product from a customer. The on-line seller determines the identity of the retail outlet where showrooming of the product occurred, and contacts the retail outlet to offer payment associated with the on-line order of the product.

### BRIEF DESCRIPTION OF THE DRAWINGS

The accompanying drawings, which are incorporated in and constitute part of the specification, illustrate various embodiments of the invention. Together with the general description, the drawings serve to explain the principles of the invention. In the drawings:

FIG. 1A is a flowchart depicting method activities to develop a supplier partnership program, according to various embodiments.

FIG. 1B is a flowchart depicting method activities to identify a brick-and-mortar retailer based on an on-line sale, according to various embodiments.

FIG. 2 depicts a communication infrastructure including computer systems and networks, and components suitable for implementing the various embodiments disclosed herein.

### DETAILED DESCRIPTION

The present inventors recognized that because buyers want to see and feel the product before buying, nearly all brick-and-mortar businesses experience the problem of showrooming at one time or another. “Showrooming” is the situation in which a person purporting to be a customer sees the product in a retail store—and often discusses the product with a salesperson and perhaps even tries the product out in the store—only to leave and shortly thereafter order the product from an on-line retailer who offers the same product for a lower price. The present inventors recognized the disadvantages that showrooming causes to brick-and-mortar retailers, and realized that many of the brick-and-mortar businesses who suffer sales losses due to showrooming would be willing to team up with an on-line seller to boost their revenues. Various embodiments of the present invention aid in teaming up on-line sellers with brick-and-mortar retailers.

The last decade brought unprecedented change to the retail industry. By far the greatest adversity affecting the future of retail has been the surge in e-commerce. In order to counter this effect, retailers need to rethink their current business methodologies and adopt innovative strategies that will enable them to remain competitive in this new economy. In this regard, the present inventors spent a considerable amount of time analyzing the retail industry, and in particular, the revenue model that exists between suppliers (S), distributors (D) and retailers (R). After careful contemplation, the present inventors reached the conclusion that the current S/D/R business structure does not adequality support or compensate D/R for their sales and marketing contributions.

Even in the age of the internet a high percentage of the consumer's first exposure to a particular product/brand is the direct result of a distributor/retailer interaction—sometimes called a brick-and-mortar retailers. This initial introduction may work in the retailers favor by leading to a direct sale. But it is just as likely that the retailer will be subject to the showrooming effect where a customer views, and perhaps tries out (or tries on), a product in the brick-and-mortar retail store, but then goes online and buys direct from the supplier at a lower price. In either case the situation is even more dire for the retailer once a customer favors a brand because the digital world makes it all too easy for that customer to go online and make future purchases direct from the supplier. This inevitable event leaves the retailer—who arguably provided the most critical step in the buying process—without any present or future compensation. In the view of the inventors this is an antiquated business practice and because of this the Supplier Partnership Program was developed.

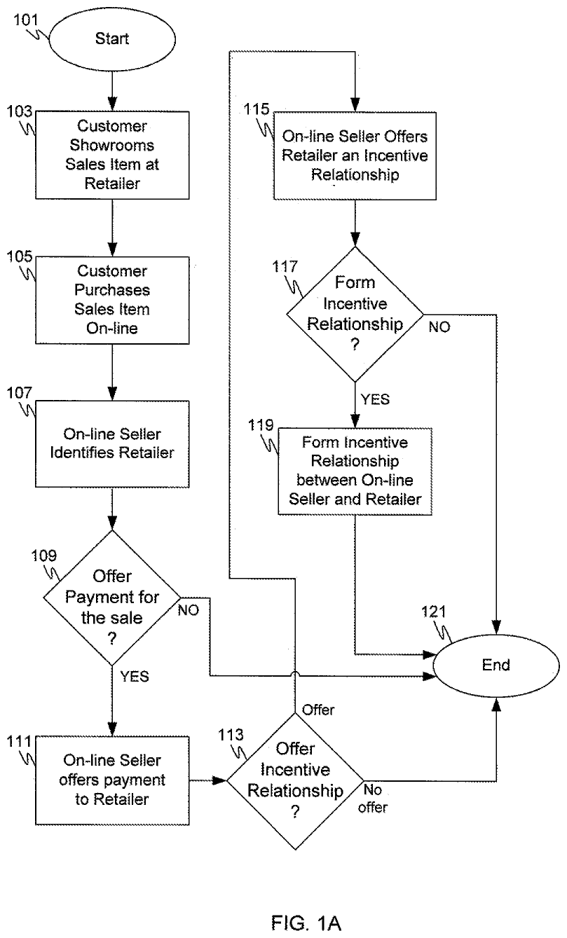

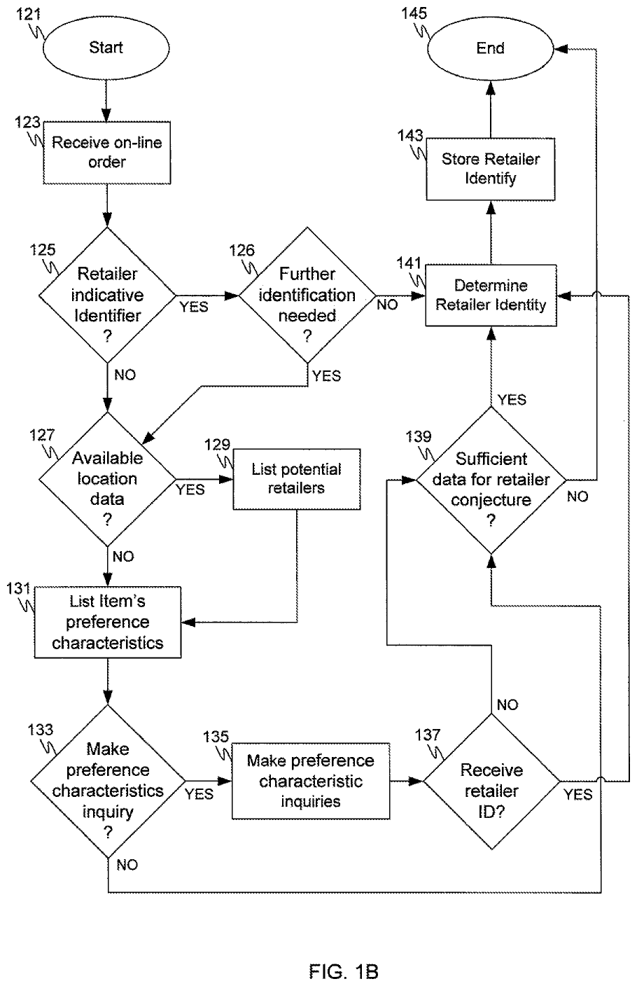

FIG. 1A is a flowchart depicting activities in a method to develop a supplier partnership program between an on-line seller and a brick-and-mortar store, according to various embodiments. The method begins in block 101 and proceeds to block 103 where a potential customer enters a brick-and-mortar retail store to shop for a given product or other sales item. A product may simply be some item that is being offered for sale in the retail store. It could be an article of clothing, a piece of consumer electronics, sporting goods equipment, a tool, an item of housewares, or any product offered for sale in brick-and-mortar retail stores as known to those of ordinary skill in the art. Customers often like to see and inspect—and sometime even try on clothing or try out a device—before making a purchase decision. But many customers will try to find the best price for an item on-line once they've seen and tried out the product at a brick-and-mortar retail store.

In block 105 of FIG. 1A the customer has decided against purchasing the sales item at the brick-and-mortar retailer, and instead purchases it from an on-line seller that is contractually unaffiliated with the brick-and-mortar retailer. This is a common problem faced by brick-and-mortar retailers. The customer uses their store as a showroom, then purchases the item from the lowest cost source—often from an on-line seller. The term “contractually unaffiliated”, as this term is used herein, means that the two parties have no prior business relationship in regards to the sale item, and as such, the on-line seller does not owe the brick-and-mortar retailer any compensation for the showrooming of the sales item in the retailer's store. A “prior business relationship” means that the on-line seller is contractually obligated to compensate the brick-and-mortar retailer for showrooming the sales item. In block 107 the on-line seller identifies the brick-and-mortar retailer where the customer showroomed the item. This may be done in any of several ways. For example, if the customer searches the on-line seller using a QR code (Quick Response code) or other retailer indicative identifier such as a retailer bar code specific to the retailer. The on-line seller may use this QR code or other retailer indicative identifier to discover the particular retailer where the product was being offered for sale. FIG. 1B, discussed below, provides further details about the on-line seller identifying the retailer in block 107.

Once the retailer is identified in block 107 the method proceeds to block 109 where the on-line seller decides whether or not to contact the brick-and-mortar retailer and offer the retailer payment for the sale which may lead to a contractual incentive relationship. The on-line seller may contact the manager of the particular store itself in block 107, or may opt to contact staff within the headquarters of its associated chain of retail stores or other person with the authority to enter into a contract on behalf of the brick-and-mortar retailer. The phrase “contacting the retail outlet” means to contact a person who works for the brick-and-mortar retailer with the authority to enter into a contractual relationship.

Returning to block 109, if the on-line seller opts not to contact the brick-and-mortar retailer the method proceeds along the “NO” path to block 121 and ends. However, if the on-line seller decides in block 109 to offer the brick-and-mortar retailer an Incentive Relationship the method proceeds along the “YES” path to block 111. The payment is associated with the on-line seller's receipt of an on-line order for the product. The payment for the first on-line sale will likely only be a dollar or two for the single sale. In some embodiments an offer may not be made for the first sale, or even for the first handful of sales. Instead, records are kept of sales and an offer is made in block 111 for a number of sales. For example, the offer for multiple sales could be phrased something like: “Our records indicate that ten people have purchased products from us on-line after viewing those products at your store, and we′d like to offer you a percentage of those ten sales as an incentive payment.” If the manager of the brick-and-mortar retailer (or other person contacted) turns down the incentive payment it's not likely that a retail Incentive Relationship will be formed at that time. The Incentive Relationship may be thought of as a reciprocating business relationship between Suppliers, Distributors and Retailers, and is sometimes called an SDR Partnership Program. Upon offering payment in block 111 the method proceeds to block 113.

In block 113 the on-line retailer decides whether to offer an Incentive Relationship with the brick-and-mortar retailer. It may be the case that, based on offering payment in block 111 an offer for an Incentive Relationship will not be made at that time. This might be because more research is required to determine the terms (e.g., percent of sales to be paid) to be offered. If no offer is to be made at that time the method proceeds from block 113 along the “No Offer” path to block 121 and ends. However, if it is decided in block 113 to go forward with the Incentive Relationship Offer the method proceeds from block 113 along the “Offer” path to block 115.

In block 115 the on-line seller offers to form a contractual Incentive Relationship with the brick-and-mortar retailer. The retailer compensation of the Incentive Relationship may be structured in the form of a percentage of the sales price, a percentage of the profit (or other accounting category related to the product), a fixed amount per item, a fixed amount per time period (e.g., a monthly amount), or any other fee arrangement suitable to both parties, as known by those of ordinary skill in the art. In this way the brick-and-mortar retailer receives compensation for use of the retail store, and the on-line seller gains the trust and allegiance of the brick-and-mortar retailer. This often results in having the retailer offer the option to buy on-line as part of their sales forces' marketing spiel to potential clients, thus resulting in another aspect of a mutually advantageous relationship. The Incentive Relationship affords the on-line seller the use of a showroom for their products. As part of the Incentive Relationship the on-line seller may enlist the brick-and-mortar retailer to serve as a delivery point for purchased items for other customers who have visited the store then placed on-line orders, and even for those who are buying on-line but may not have been customers of the brick-and-mortar store. In this way the on-line seller could improve shipping efficiency by shipping multiple items to the brick-and-mortar retailer within the same package. It also increases foot traffic to the brick-and-mortar retailer's store, a mutually beneficial situation.

The method proceeds from block 115 to block 117 where the parties make a decision as to forming an Incentive Relationship—namely, the brick-and-mortar retailer decides whether or not to accept the offer, or further negotiate, or turn down the offer. If block 117 results in a determination not to form a relationship the method proceeds from block 117 along the “NO” path to block 121, and ends. However, if the brick-and-mortar retailer agrees to the on-line seller's offer, the method proceeds from block 117 to block 119 along the “YES” path. In block 119 the on-line seller and brick-and-mortar retailer discuss the terms of the Incentive Relationship until reaching agreement and forming a contract, thus providing compensation to the brick-and-mortar retailer. It is significant that compensation is provided, and a contractual relationship is formed for future compensation, despite there being no prior contact to the parties. The compensation is for the customer's contact with the brick-and-mortar retailer—that is, the showrooming—for which the retailer had no expectation of compensation. Further aspects of the contractual Incentive Relation are discussed below, following the discussion of FIG. 1B. Once a contractual Incentive Relationship has been formed the method proceeds from block 119 to block 121 and ends.

FIG. 1B is a flowchart depicting method activities to identify a brick-and-mortar retailer based on an on-line sale, according to various embodiments. This figure provides details of block 107 of FIG. 1A to identify the brick-and-mortar retailer at which the customer showroomed the sale item. The method begins at block 121 and proceeds to 123 where the on-line seller receives an on-line order to purchase an item. In block 125 the on-line seller determines whether a Retailer Indicative Identifier was used by the customer to place the on-line order. The Retailer Indicative Identifier specific to one retailer (or chain of retailers) may be a QR code (Quick Response code), a proprietary model number, mention of a trademarked or copyrighted term, or other identifying information known to those of ordinary skill in the art that could indicate the identity of the brick-and-mortar retailer. The Retailer Indicative Identifier may be gleaned from stored data accessed by the on-line seller from past transactions, determined through a computer search or other research, or provided by manufacturers, chains of stores or wholesalers indicating the retail outlets they sell to.

If a Retailer Indicative Identifier is discovered in block 125 that positively identifies a brick-and-mortar retail the method proceeds along the “YES” path to block 126. In block 126 it is determined whether additional identification is needed. For example, it may be the case that the Retailer Indicative Identifier indicates several stores that sell a given product, or there may be some other reason for uncertainty in identifying the correct retailer. In such situations it is desirable to perform additional steps to increase the chances of correctly identifying the retail store and the method proceeds from block 126 along the “YES” path to block 127. If, in block 126, it is determined that no further steps are to be taken to identify the retailer the method proceeds along the “NO” path to block 141 where the identification of the brick-and-mortar retailer is obtained. Upon completing block 141 the method proceeds to block 143 to store the identifying information of the retailer, and then to block 145 where the method ends.

Returning to block 126 if further steps are to be taken to identify the brick-and-mortar retailer, then the method proceeds along the “YES” path to block 127. In block 127 it is determined whether any geographic location data was discovered during the on-line transaction. Geographic location data may be obtained through a reverse phone number look-up if the order is placed by landline telephone or a cell phone. If the order is placed by computer the geographic location may be discovered by looking up the street address associated with the IP address of the computer placing the order. If the order is being placed by a cellular telephone the geographic location may be obtained by looking up the street address associated with the phone's IP address, or the street address associated with the IP address node of the wi-fi being used to place the order. Geographic location data may be discovered using white page telephone book databases, yellow page telephone book databases, in-house compiled street address databases, as well as databases of telephone numbers purchased from telephone companies, cellular telephone providers or third-party vendors. Geographic location data may also be purchased from a credit card provider or obtained from point-of-sale data service companies such as such as Clover™, Toast™, Lightspeed™, Upserve™, Posnation™, Rezku™ and/or other companies, vendors or financial point-of-sale (POS) service companies. Geographic location data may be obtained by other methods and sources, as are known by those of ordinary skill in the art. Returning to block 127, if geographic location data is obtained the method proceeds along the “YES” path to block 129 to obtain a list of potential brick-and-mortar retailers in the area, and then on to block 131. However, if block 127 results in no geographic location data being obtained after a reasonable amount of search time, the method proceeds along the “NO” path to block 131.

In block 131 it the preference characteristics of the purchased item are listed and questions are formulated in regard to the item's preference characteristics. This may be done ahead of time in anticipation of taking on-line sales orders. Preference characteristics are the traits of an item that can be perceived by a human and make that item preferable to a given customer over other items. For example, preference characteristics include the color, shape, size, texture and quality of materials of nearly all sales items. Preference characteristics also include traits like the fit and style of clothing, and the fit, flexibility and style of shoes. Preference characteristics may include the knurling or shape of a tool's handle, or the tool's weight or balance. Upon completing block 131 the method proceeds to block 133.

In block 133 it is decided whether or not to make one or more inquiries regarding the preference characteristics while taking the on-line order. If no inquiry is to be made the method proceeds from block 133 via the “NO” path to block 139. If one or more preference characteristic inquiries are to be made during the on-line sales order the method proceeds from block 133 via the “YES” path to block 135. The preference characteristic inquiries are typically written inquiries, but if the on-line order is being taken via telephone they may be spoken inquiries. An example of a preference characteristic inquiry for a shoe order might be: “Shoes sizes of different vendors may vary somewhat. Have you tried on the shoes of the ABC shoe company to confirm your correct shoe size?” The inquiry may be more generic, not referring to any particular characteristic. For example, the inquiry could be: “The look and feel, and features of battery powered electric drills can vary widely from one vendor to the next. Have you tried out this model of the Bosch™ drill before making your purchase decision?” In this way—in making the preference characteristic inquiries—it can be determined whether or not showrooming took place by this customer prior to the on-line order. Upon making the preference characteristic inquiry in block 135 the method proceeds to block 137 to determine whether the customer revealed the identity of the brick-and-mortar retailer.

It is sometimes the case that the customer will reveal the identity of the brick-and-mortar retailer during the on-line sales order. For example, the customer may respond to the preference characteristic inquiry, stating: “Yes, I tried out the Bosch™ electric drill at my local True Value™ hardware store.” In such instances the method proceeds from block 137 along the “YES” path to block 141. However, if the identity of the brick-and-mortar retailer was not made known during the on-line order, the method proceeds from block 137 along the “NO” path to block 139.

In block 139 it is determined whether or not there is sufficient data to formulate a conjecture as to the identity of the brick-and-mortar retailer identity. The data typically includes one or more of: retailer indicative identifier data, location data, and customer responses to preference characteristic inquiries, as well as the brand and type of the sales item. Since there is a limited number of retail outlets within shopping proximity of the consumer, the data is used to indicate the identity of the brick-and-mortar retailer that can be considered most likely to have been used for showrooming. It may be the case that the retailer is sometimes incorrectly identified. There is no downside or penalty to this since it is impossible for the retailer to prove or disprove that the consumer viewed his product before making an on-line purchase (so long as the retailer actually sells the particular item, and it is available for viewing at the store). If it is determined in block 139 that the data is insufficient the method proceeds along the “NO” path to block 145 and ends. However, if it is determined in block 139 that there is sufficient data to provide a conjecture for the brick-and-mortar retailer the method proceeds along the “YES” path to block 141.

In block 141 the brick-and-mortar retailer is identified based on the gathered data and information about the sales item. At minimum there needs to be some sort of location data to determine the retailer identity. With only location data to go on, the program can surmise that the closest brick-and-mortar retailer to the customer is the site of the showrooming. This would be the least accurate method using the minimum amount of data available. More data points make the conjecture about the brick-and-mortar retailer's identity more likely to be accurate. The term “retailer identity”, as this term is used herein, is in fact actually a retailer identity conjecture since it may not always be known with absolute certainty that the correct retailer has been selected, absent a truthful admission by the customer during the on-line order. Once the retailer identity is decided upon in block 141 the method proceeds to block 143 to store the retailer identity in a database or other format contained in a machine-readable media (e.g., computer storage or memory).

In block 119 of FIG. 1A a contractual Incentive Relationship is formed and compensation is provided to the brick-and-mortar retailer. The contractual Incentive Relationship may be called a Supplier/Distributor/Retailer partnership, or SDR Partnership. The SDR Partnership Program was designed to create a reciprocating business relationship between suppliers, distributors and retailers. This system is typically a web-based software system built by bundling existing computer and web technologies into a unique framework. Prior to creation of the SDR Partnership nothing like this arrangement exists in the retail industry. The SDR Partnership program runs counter to the current status quo in the retail sector by compensating retailers for purchases that are made by customers who eventually end up buying from on-line suppliers.

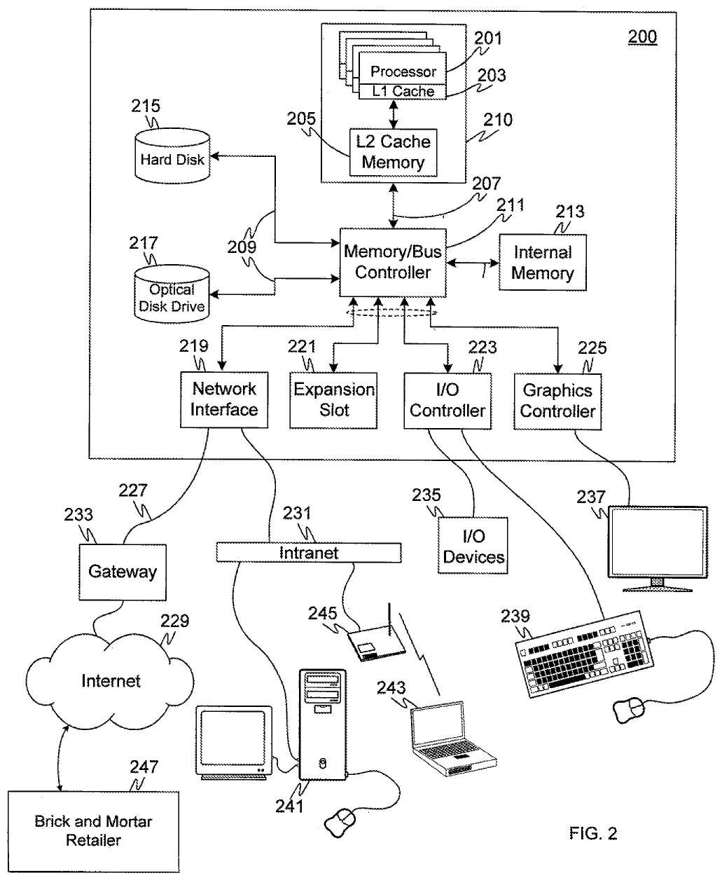

FIG. 2 depicts a communication infrastructure including computer system 200 and various components suitable for implementing the various embodiments disclosed herein. The computer system 200 may be configured in the form of a desktop computer, a laptop computer, a mainframe computer, or any other hardware or logic arrangement capable of being programmed or configured to carry out instructions. The computer system 200 may be embodied as an admin server that performs various functions, activities and methods described above. In some embodiments the computer system 200 may act as a server, accepting inputs from a remote user over a local area network (LAN) 227, the Internet 229, or an intranet 231. In other embodiments, the computer system 200 may function as a smart user interface device for a server on the LAN 227 or over the Internet 229. The computer system 200 may be located and interconnected in one location, or may be distributed in various locations and interconnected via communication links such as a LAN 227 or a wide area network (WAN), via the Internet 229, via the public switched telephone network (PSTN), a switching network, a cellular telephone network, a wireless link, or other such communication links. The brick-and-mortar retailer 247 may be connected to the Internet 229. Other devices may also be suitable for implementing or practicing the embodiments, or a portion of the embodiments. Such devices include personal digital assistants (PDA), wireless handsets (e.g., a cellular telephone or pager), and other such electronic devices preferably capable of being programmed to carry out instructions or routines. Those of ordinary skill in the art may recognize that many different architectures may be suitable for the computer system 200, although only one typical architecture is depicted in FIG. 2.

Computer system 200 may include a processor 201 which may be embodied as a microprocessor, two or more parallel processors as shown in FIG. 2, a central processing unit (CPU) or other such control logic or circuitry. The processor 201 may be configured to access a local cache memory 203, and send requests for data that are not found in the local cache memory 203 across a cache bus to a second level cache memory 205. Some embodiments may integrate the processor 201, and the local cache 203 onto a single integrated circuit and other embodiments may utilize a single level cache memory or no cache memory at all. Other embodiments may integrate multiple processors 201 onto a single die and/or into a single package. Yet other embodiments may integrate multiple processors 201 with multiple local cache memories 203 with a second level cache memory 205 into a single package 210 with a front side bus 207 to communicate to a memory/bus controller 211. The memory/bus controller 211 may accept accesses from the processor(s) 201 and direct them to either the internal memory 213 or to the various input/output (I/O) busses 209. Some embodiments of the computer system 200 may include multiple processor packages 210 sharing the front-side bus 207 to the memory/bus controller. Other embodiments may have multiple processor packages 210 with independent front-side bus connections to the memory/bus controller. The memory bus controller may communicate with the internal memory 213 using a memory bus 209.

The internal memory 213 may include one or more of random access memory (RAM) devices such as synchronous dynamic random access memories (SDRAM), double data rate (DDR) memories, or other volatile random access memories. The internal memory 213 may also include non-volatile memories such as electrically erasable/programmable read-only memory (EEPROM), NAND flash memory, NOR flash memory, programmable read-only memory (PROM), read-only memory (ROM), battery backed-up RAM, or other non-volatile memories. In some embodiments, the computer system 200 may also include 3^{rd} level cache memory or a combination of these or other like types of circuitry configured to store information in a retrievable format. In some implementations the internal memory 213 may be configured as part of the processor 201, or alternatively, may be configured separate from it but within the same package 210. The processor 201 may be able to access internal memory 213 via a different bus or control lines than is used to access the other components of computer system 200.

The computer system 200 typically includes, or has access to, one or more non-transitory computer readable storage mediums such as hard drives 215, optical disk drives 217 or other types of non-transitory computer readable storage memory. Hard drives 215 and the optical disks for optical disk drives 217 are examples of computer readable machine readable (also called computer readable) mediums suitable for storing the final or interim results of the various embodiments. The optical disk drives 217 may include a combination of several disc drives of various formats that can read and/or write to removable storage media (e.g., CD-R, CD-RW, DVD, DVD-R, DVD-W, DVD-RW, HD-DVD, Blu-Ray, and the like). Other forms of computer readable computer readable media that may be implemented in some embodiments of computer system 200 include, but are not limited to, floppy disk drives, 9-track tape drives, tape cartridge drives, solid-state drives, cassette tape recorders, paper tape readers, bubble memory devices, magnetic strip readers, punch card readers or other types of non-transitory computer readable storage mediums known to those of ordinary skill in the art.

The computer system 200 may either include the hard drives 215 and optical disk drives 217 as an integral part of the computer system 200 (e.g., within the same cabinet or enclosure and/or using the same power supply), as connected peripherals, or may access the hard drives 215 and optical disk drives 215 over a network, or a combination of these. The hard drive 215 often includes a rotating magnetic medium configured for the storage and retrieval of data, computer programs or other information. In some embodiments, the hard drive 215 may be a solid-state drive using semiconductor memories. In other embodiments, some other type of computer useable medium may be used. The hard drive 215 need not necessarily be contained within the computer system 200. For example, in some embodiments the hard drive 215 may be server storage space within a network that is accessible to the computer system 200 for the storage and retrieval of data, computer programs or other information. In some instances, the computer system 200 may use storage space at a server storage farm, or like type of storage facility, that is accessible by the Internet 229 or other communications lines. The hard drive 215 is often used to store the software, instructions and programs executed by the computer system 200, including for example, all or parts of the computer application program for carrying out activities of the various embodiments. A non-transitory computer readable storage medium such as hard drive 215 in a computer system 200 typically includes instructions that, upon being executed by a processor such as processor 201, cause the processor 201 to perform activities in a method, e.g., the methods depicted in FIGS. 1A and 1B.

The communication link 209 may be used to access the contents of the hard drives 215 and optical disk drives 217. The communication links 209 may be point-to-point links such as Serial Advanced Technology Attachment (SATA) or a bus type connection such as Parallel Advanced Technology Attachment (PATA) or Small Computer System Interface (SCSI), a daisy chained topology such as IEEE-1394, a link supporting various topologies such as Fibre Channel, or any other computer communication protocol, standard or proprietary, that may be used for communication to computer readable medium. The memory/bus controller may also provide other I/O communication links 209. In some embodiments, the links 209 may be a shared bus architecture such as peripheral component interface (PCI), microchannel, industry standard architecture (ISA) bus, extended industry standard architecture (EISA) bus, VERSAmoduleEurocard (VME) bus, or any other shared computer bus. In other embodiments, the links 209 may be a point-to-point link such as PCI-Express, HyperTransport, or any other point-to-point I/O link. Various I/O devices may be configured as a part of the computer system 200.

In many embodiments, a network interface 219 may be included to allow the computer system 200 to connect to a network 227 or 231. Either of the networks 227 and 231 may operate in accordance with standards for an IEEE 802.3 ethernet network, an IEEE 802.11 Wi-Fi wireless network, or any other type of computer network including, but not limited to, LANs, WAN, personal area networks (PAN), wired networks, radio frequency networks, powerline networks, and optical networks. A network gateway 233 or router, which may be a separate component from the computer system 200 or may be included as an integral part of the computer system 200, may be connected to the networks 227 and/or 231 to allow the computer system 200 to communicate with the Internet 229 over an internet connection such as an asymmetric digital subscriber line (ADSL), data over cable service interface specification (DOCSIS) link, T1 or other internet connection mechanism. In other embodiments, the computer system 200 may have a direct connection to the Internet 229. The computer system 200 may be connected to one or more other computers such as desktop computer 241 or laptop computer 243 via the Internet 229, an intranet 231, and/or a wireless node 245. In some embodiments, an expansion slot 221 may be included to allow a user to add additional functionality to the computer system 200.

The computer system 200 may include an I/O controller 223 providing access to external communication interfaces such as universal serial bus (USB) connections, serial ports such as RS-232, parallel ports, audio in and audio out connections, the high performance serial bus IEEE-1394 and/or other communication links. These connections may also have separate circuitry in some embodiments, or may be connected through a bridge to another computer communication link provided by the I/O controller 223. A graphics controller 225 may also be provided to allow applications running on the processor 201 to display information to a user. The graphics controller 225 may output video through a video port that may utilize a standard or proprietary format such as an analog video graphic array (VGA) connection, a digital video interface (DVI), a digital high definition multimedia interface (HDMI) connection, or any other video connection. The video connection may connect to display 237 to present the video information to the user.

The display 237 may be any of several types of displays or computer monitors, including a liquid crystal display (LCD), a cathode ray tube (CRT) monitor, on organic light emitting diode (OLED) array, or other type of display suitable for displaying information for the user. The display 237 may include one or more light emitting diode (LED) indicator lights, or other such display devices. Typically, the computer system 200 includes one or more user input/output (I/O) devices such as a keyboard and mouse 239, and/or other means of controlling the cursor represented including but not limited to a touchscreen, touchpad, joystick, trackball, tablet, or other device. The user I/O devices 235 may connect to the computer system 200 using USB interfaces or other connections such as RS-232, PS/2 connector or other interfaces. Various embodiments include input devices configured to accept an input from a user and/or provide an output to a user. For example, some embodiments may include a webcam (e.g., connect via USB), a microphone (e.g., connected to an audio input connection), and/or speakers (e.g., connected to an audio output connection). The computer system 200 typically has a keyboard and mouse 239, a monitor 237, and may be configured to include speakers, microphone, and a webcam. These input/output devices may be used in various combinations, or separately, as means for presenting information to the user and/or receiving information and other inputs from a user to be used in carrying out various programs and calculations. Speech recognition software may be used in conjunction with the microphone to receive and interpret user speech commands.

The computer system 200 may be suitable for use in identifying critical web services and dynamically relocating them to a new server. For example, the processor 201 may be embodied as a microprocessor, microcontroller, DSP, RISC processor, two or more parallel processors, or any other type of processing unit that one of ordinary skill would recognize as being capable of performing or controlling the functions, steps, activities and methods described herein. A processing unit in accordance with at least one of the various embodiments can operate computer software programs stored (embodied) on computer-readable medium such those compatible with the disk drives 215, the optical disk drive 217 or any other type of hard disk drive, floppy disk, flash memory, ram, or other computer readable medium as recognized by those of ordinary skill in the art.

As will be appreciated by those of ordinary skill in the art, aspects of the various embodiments may be embodied as a system, method or computer program product. Accordingly, aspects of the present invention may take the form of an entirely hardware embodiment, an entirely software embodiment (including firmware, resident software, micro-code, or the like) or an embodiment combining software and hardware aspects that may all generally be referred to herein as a “circuit,” “module,” “logic” or “system.” Furthermore, aspects of the various embodiments may take the form of a computer program product embodied in one or more computer readable medium(s) having computer readable program code stored thereon.

Any combination of one or more non-transitory computer readable medium(s) may be utilized. The computer readable medium is typically a computer readable storage medium. A computer readable storage medium may be embodied as, for example, an electronic, magnetic, optical, electromagnetic, infrared, or semiconductor system, apparatus, or device, or other like storage devices known to those of ordinary skill in the art, or any suitable combination of the foregoing. Examples of such computer readable storage medium include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations and aspects of the various embodiments may be written in any combination of one or more programming languages, including an object-oriented programming language such as Java, Smalltalk, C++, or the like, and conventional procedural programming languages, such as the “C” programming language or similar programming languages, or any other computer languages or programs known to those of ordinary skill in the art. In accordance with various implementations, the program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus, systems, and computer program products according to various embodiments disclosed herein. It will be understood that blocks of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, a programmable data processing apparatus, or other such devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks. The flowchart and/or block diagrams in the figures help to illustrate the architecture, functionality, and operation of possible implementations of systems, methods and computer program products according to various embodiments. In this regard, each block in the flowchart or block diagrams may represent a module, segment, or portion of a program of instructions, code or other logic, which comprises one or more executable instructions for implementing the specified logical function(s).

It should also be noted that, in some alternative implementations, the functions noted in the block may occur in an order other than that depicted in the figures. For example, two blocks shown in succession may, in fact, be executed substantially concurrently, or the blocks and activities of the figures may sometimes be executed in reverse order or in a different order, depending upon the functionality involved. For example, the listing of the item's preference characteristics in block 131 of FIG. 1B take place at any time after (or during) the block 123 activity of receiving an on-line order. Another example arises with the offer of payment in block 111. The offer of payment may be made in conjunction with the offer to form an Incentive relationship in blocks 117/119. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises,” “comprising,” “includes,” and/or “including” used in this specification specify the presence of stated features, integers, steps, operations, elements, and/or components, but do not preclude the presence or addition of one or more other features, integers, steps, operations, elements, components, and/or groups thereof. The term “obtaining”, as used herein and in the claims, may mean either retrieving from a computer readable storage medium, receiving from another computer program, receiving from a user, calculating based on other input, or any other means of obtaining a datum or set of data. The term “plurality”, as used herein and in the claims, means two or more of a named element. It should not, however, be interpreted to necessarily refer to every instance of the named element in the entire device. Particularly, if there is a reference to “each” element of a “plurality” of elements. There may be additional elements in the entire device that are not be included in the “plurality” and are not, therefore, referred to by “each.”

A “brick-and-mortar retailer” (sometimes called a retail outlet or retailer), as this term is used herein, refers to a place of business with a street address that can be visited by customers who may make purchases if they so choose. A Walmart™ store is a brick-and-mortar retailer. Amazon.com™ is not a brick-and-mortar retailer. In some instances, activities described as being done with a brick-and-mortar retailer are actually performed by the retail outlet manager or other staff on behalf of the brick-and-mortar retailer. For example, the specification states that “the on-line seller and brick-and-mortar retailer discuss the terms of the Incentive Relationship until reaching agreement.” The word “manager” is implied, as is evident from context. What is meant is “staff of the on-line seller and a manager of the brick-and-mortar retailer discuss the terms of the Incentive Relationship until reaching agreement.” A brick-and-mortar retailer may also sell items on-line.

An “on-line seller”, as this term is used herein, is a business that takes orders for goods remotely, for example, either over the Internet or by telephone. It could be possible for a business to be both an on-line seller and a brick-and-mortar retailer. Quite often, however, on-line sellers do not have brick-and-mortar stores. An “on-line order” (or “remote sales order”), as this term is used herein, is an order that's placed remotely by a person via the Internet or a telephone. The product being bought using an on-line order must be shipped to the customer. The term “showrooming”, as this term is used herein, occurs when a customer visits a brick-and-mortar retailer to see a product offered for sale, but then purchases the product from an on-line seller. The term “product” (or “item” or “sale item”), as this term is used herein, may be any product being offered for sale at a brick-and-mortar retailer.

An “Incentive Relationship”, as this term is used herein, is a contractual relationship between an on-line seller and a brick-and-mortar retailer. A “Retailer Indicative Identifier”, as this term is used herein, is a code that identifies one specific to retailer or chain of retailers. A Retailer Indicative Identifier may be a QR code (Quick Response code), a proprietary model number, a manufacturer part number (MPN), a global trade number (GTIN), an international standard book number (ISBN), a retailer bar code, a brand name, a copyrighted brand name, a description of a logo, color or texture, a mention of material subject to copyright, design patent or trademark, or any other identifying information known to those of ordinary skill in the art that could indicate the identity of the brick-and-mortar retailer. The term “geographic location data”, as this term is used herein, is data or information that sheds light on the location of something. The geographic location data may indicate a location or locale of the customer or the brick-and-mortar retailer. The geographic location data may indicate an exact street address, or may specify a state, county, region or telephone area code where the item is located. The term “street address data”, as this term is used herein, means a location or address to which the U.S. Postal Service delivers mail.

The description of the present invention has been presented for purposes of illustration and description, but is not intended to be exhaustive or limited to the invention in the form disclosed. Many modifications and variations will be apparent to those of ordinary skill in the art without departing from the scope and gist of the invention. The various embodiments included herein were chosen and described in order to best explain the principles of the invention and the practical application, and to enable others of ordinary skill in the art to understand the invention for various embodiments with various modifications as are suited to the particular use contemplated. The corresponding structures, materials, acts, and equivalents of all means or step plus function elements in the claims below are intended to include any structure, material, or act for performing the function in combination with other claimed elements as specifically claimed.

1. A non-transitory computer readable storage medium including instructions that, upon being executed by a processor, cause the processor to perform a method for providing compensation from an on-line seller to a retail outlet, the method comprising:
receiving, at the on-line seller, an on-line order for a product from a customer;
determining an identity of the retail outlet where showrooming of the product occurred, the retail outlet being contractually unaffiliated with the on-line seller;
receiving a decision by the on-line seller to contact the retail outlet; and
receiving an indication from the on-line seller of an offer to the retail outlet for payment associated with the on-line order of the product.

2. The non-transitory computer readable storage medium of claim 1, wherein the retail outlet is a brick-and-mortar retailer.

3. The non-transitory computer readable storage medium of claim 1, wherein the on-line order is placed via an Internet connection; and
wherein the on-line seller and the retail outlet have no prior business relationship in regards to the sale item.

4. The non-transitory computer readable storage medium of claim 1, wherein the activities further comprise:
detecting an indication of showrooming the product.

5. The non-transitory computer readable storage medium of claim 4, wherein the activities further comprise:
offering the retail outlet an incentive relationship;
wherein the incentive relationship is a contractual relationship that provides compensation to the retail outlet for an on-line purchase of a product in which a customer viewed the product at the retail outlet prior to making the on-line purchase.

6. The non-transitory computer readable storage medium of claim 5, wherein said determining the identity further comprises:
detecting location data from the on-line order.

7. The non-transitory computer readable storage medium of claim 5, wherein said determining the identity further comprises:
receiving a retail indicative identifier in the on-line order.

8. The non-transitory computer readable storage medium of claim 5, wherein said determining the identity further comprises:
making a preference characteristic inquiry in the on-line order.

9. A method of providing compensation from an on-line seller to a retail outlet comprising:
receiving, at the on-line seller, an on-line order for a product from a customer;
determining an identity of the retail outlet where showrooming of the product occurred, the retail outlet being contractually unaffiliated with the on-line seller;
the on-line seller contacting the retail outlet; and
the on-line seller offering the retail outlet payment associated with the on-line order of the product.

10. The method of claim 9, wherein the retail outlet is a brick-and-mortar retailer.

11. The method of claim 9, wherein the on-line order is placed via an Internet connection.

12. The method of claim 9, further comprising:
detecting an indication of showrooming the product.

13. The method of claim 12, further comprising:
offering the retail outlet an incentive relationship;
wherein the incentive relationship is a contractual relationship that provides compensation to the retail outlet for an on-line purchase of a product in which a customer viewed the product at the retail outlet prior to making the on-line purchase.

14. The method of claim 13, wherein said determining the identity further comprises:
detecting location data from the on-line order.

15. The method of claim 13, wherein said determining the identity further comprises:
receiving a retail indicative identifier in the on-line order.

16. The method of claim 13, wherein said determining the identity further comprises:
making a preference characteristic inquiry in the on-line order.
